(19) United States
(12) Patent Application Publication
(10) Pub. No.: US 2012/0054703 A1
(43) Pub. Date: Mar. 1, 2012

(54) Virtual Flat Traversal Of A Hierarchical Circuit Design

(76) Inventors: G. Fedor Pikus, Beaverton, OR (US); Ziyang Lu, Camas, WA (US); Phillip A. Brooks, Tualatin, OR (US)

(21) Appl. No.: 12/868,717

(22) Filed: Aug. 25, 2010

(51) Int. Cl. G06F 17/50

(52) U.S. Cl. 716/107

(57) ABSTRACT

Configuration templates reflect configuration information described in hierarchical circuit design data. The object configure information will include both template generic configuration information and instance specific configuration information. The template generic configuration information is configuration information that is common to all instantiations of a corresponding cell in the hierarchical circuit design data. The instance specific configuration information is then configuration information that is particular to one or more specific instantiations of the corresponding cell in the hierarchical circuit design data. After the object configuration templates have been generated, a configuration information analysis unit uses the object configuration information contained in the object configuration templates to identify objects having configuration data that match defined configuration criteria.

### FIELD OF THE INVENTION

The present invention is directed to the identification of specific data within a hierarchical circuit design. Various implementations of the invention may be useful for performing various electronic design automation processes on a hierarchically organized design of an integrated circuit.

### BACKGROUND OF THE INVENTION

Electronic circuits, such as integrated microcircuits, are used in a variety of products, from automobiles to microwaves to personal computers. Designing and fabricating microcircuit devices typically involves many steps, known as a “design flow.” The particular steps of a design flow often are dependent upon the type of microcircuit being designed, its complexity, the design team, and the microcircuit fabricator or foundry that will manufacture the microcircuit. Typically, software and hardware “tools” will verify a design at various stages of the design flow by running software simulators and/or hardware emulators, and errors in the design are corrected.

Several steps are common to most design flows. Initially, the specification for the new microcircuit is transformed into a logical design, sometimes referred to as a register transfer level (RTL) description of the circuit. With this logical design, the circuit is described in terms of both the exchange of signals between hardware registers and the logical operations that are performed on those signals. The logical design typically employs a Hardware Design Language (HDL), such as the Very high speed integrated circuit Hardware Design Language (VHDL). The logical of the circuit is then analyzed, to confirm that the logic incorporated into the design will accurately perform the functions desired for the circuit. This analysis is sometimes referred to as “functional verification.”

After the accuracy of the logical design is confirmed, it is converted into a device design by synthesis software. The device design, which is typically in the form of a schematic or netlist, describes the specific electronic devices (such as transistors, resistors, and capacitors) that will be used in the circuit, along with their interconnections. This logical generally corresponds to the level of representation displayed in conventional circuit diagrams. Preliminary timing estimates for portions of the circuit may be made at this stage, using an assumed characteristic speed for each device. In addition, the relationships between the electronic devices are analyzed, to confirm that the circuit described by the device design will correctly perform the functions desired for the circuit. This analysis is sometimes referred to as “formal verification.”

Once the relationships between circuit devices have been established, the design is again transformed, this time into a physical design that describes specific geometric elements. This type of design often is referred to as a “layout” design. The geometric elements define the shapes that will be created in various materials to actually manufacture the circuit device components (e.g., contacts, gates, etc.) making up the circuit. While the geometric elements are typically polygons, other shapes, such as circular and elliptical shapes, also may be employed. These geometric elements may be custom designed, selected from a library of previously-created designs, or some combination of both. Geometric elements also are added to form the connection lines that will interconnect these circuit devices. Layout tools (often referred to as “place and route” tools), such as Mentor Graphics' IC Station or Cadence's Virtuoso, are commonly used for both of these tasks.

With a layout design, each physical layer of the microcircuit will have a corresponding layer representation, and the geometric elements described in a layer representation will define the relative locations of the circuit device components that will make up a circuit device. Thus, the geometric elements in the representation of an implant layer will define the regions where doping will occur, while the geometric elements in the representation of a metal layer will define the locations in a metal layer where conductive wires used will be formed to connect the circuit devices. Typically, a designer will perform a number of analyses on the layout design. For example, the layout design may be analyzed to confirm that it accurately represents the circuit devices and their relationships described in the device design. The layout design also may be analyzed to confirm that it complies with various design requirements, such as minimum spacings between geometric elements. Still further, it may be modified to include the use of redundant or other compensatory geometric elements intended to counteract limitations in the manufacturing process, etc, so as to verify that the design can be manufactured with a high degree of reliability. These types of analysis processes are sometimes referred to as “physical verification” or “layout verification.”

After the layout design has been finalized, then it is converted into a format that can be employed by a mask or reticle writing tool to create a mask or reticle for use in a photolithographic manufacturing process. Masks and reticles are typically made using tools that expose a blank reticle to an electron or laser beam. Most mask writing tools are able to only “write” certain kinds of polygons, however, such as right triangles, rectangles or other trapezoids. Moreover, the sizes of the polygons are limited physically by the maximum beam aperture size available to the tool. Accordingly, larger geometric elements in the layout design, or geometric elements that are not basic right triangles, rectangles or trapezoids (which typically is a majority of the geometric elements in a layout design) must be “fractured” into the smaller, more basic polygons that can be written by the mask or reticle writing tool.

Once the layout design has been fractured, then the layout design data can be converted to a format compatible with the mask or reticle writing tool. Examples of such formats are MEBES, for raster scanning machines manufactured by ETEC, an Applied Materials Company, the “.MIC” format from Micronics AB in Sweden, and various vector scan formats for Nuflare, JEOL, and Hitachi machines, such as VSB12 or VSB12. The written masks or reticles can then be used in a photolithographic process to expose selected areas of a wafer in order to produce the desired integrated circuit devices on the wafer.

With many electronic design automation processes, it is necessary to identify design objects having a specific design configuration. Many electronic circuit designs are partitioned into a hierarchal organization, however. Because an arbitrary design configuration may involve connections or other relationships that cross the boundaries of these hierarchical partitions, it typically is necessary to flatten a hierarchical circuit design in order to ensure that all occurrences of objects with the specified design configuration are identified. This flattening of hierarchical circuit design data often increases the size of the design database to an unacceptable or impractical size.

### BRIEF SUMMARY OF THE INVENTION

Aspects of the invention relate to techniques for traversing hierarchical circuit design data in a manner that effectively flattens the data from a user's prospective. According to various implementations of the invention, an object configuration template generation unit examines hierarchical circuit design data to create object configuration templates reflecting configuration information described in the hierarchical circuit design data. With various implementations of the invention, the object configure information will include both template generic configuration information and instance specific configuration information. The template generic configuration information is configuration information that is common to all instantiations of the corresponding cell in the hierarchical circuit design data. The instance specific configuration information is then configuration information that is particular to one or more specific instantiations of the corresponding cell in the hierarchical circuit design data. After the object configuration templates have been generated, a configuration information analysis unit uses the object configuration information contained in the object configuration templates to identify objects having configuration data that match defined configuration criteria.

### BRIEF DESCRIPTION OF THE DRAWINGS

FIG. 1 illustrates an example of a computing system that may be used to implement various embodiments of the invention.

FIG. 2 illustrates an example of a multi-core processor unit that may be used to implement various embodiments of the invention.

FIG. 3 schematically illustrates an example of a family of software tools for automatic design automation that may employ associative properties according to various embodiments of the invention.

FIG. 4 illustrates a virtual flat design traversal tool that may be implemented according to various embodiments of the invention.

FIG. 5 illustrates a flowchart showing a method of virtually traversing a hierarchical circuit design according to various embodiments of the invention.

FIG. 6 illustrates a flowchart showing a method of creating object configuration templates according to various embodiments of the invention.

### DETAILED DESCRIPTION OF THE INVENTION

### Exemplary Operating Environment

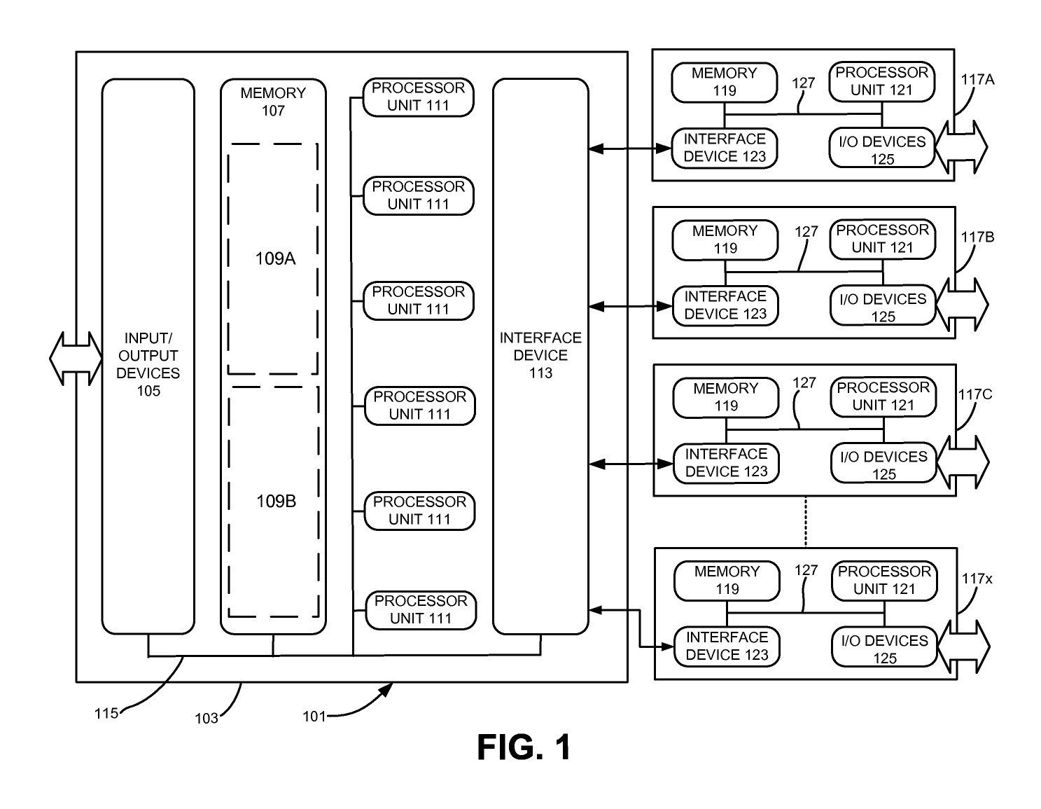

The execution of various electronic design automation processes according to embodiments of the invention may be implemented using computer-executable software instructions executed by one or more programmable computing devices. Because these embodiments of the invention may be implemented using software instructions, the components and operation of a generic programmable computer system on which various embodiments of the invention may be employed will first be described. Further, because of the complexity of some electronic design automation processes and the large size of many circuit designs, various electronic design automation tools are configured to operate on a computing system capable of simultaneously running multiple processing threads. The components and operation of a computer network having a host or master computer and one or more remote or servant computers therefore will be described with reference to FIG. 1. This operating environment is only one example of a suitable operating environment, however, and is not intended to suggest any limitation as to the scope of use or functionality of the invention.

In FIG. 1, the computer network 101 includes a master computer 103. In the illustrated example, the master computer 103 is a multi-processor computer that includes a plurality of input and output devices 105 and a memory 107. The input and output devices 105 may include any device for receiving input data from or providing output data to a user. The input devices may include, for example, a keyboard, microphone, scanner or pointing device for receiving input from a user. The output devices may then include a display monitor, speaker, printer or tactile feedback device. These devices and their connections are well known in the art, and thus will not be discussed at length here.

The memory 107 may similarly be implemented using any combination of computer readable media that can be accessed by the master computer 103. The computer readable media may include, for example, microcircuit memory devices such as read-write memory (RAM), read-only memory (ROM), electronically erasable and programmable read-only memory (EEPROM) or flash memory microcircuit devices, CD-ROM disks, digital video disks (DVD), or other optical storage devices. The computer readable media may also include magnetic cassettes, magnetic tapes, magnetic disks or other magnetic storage devices, punched media, holographic storage devices, or any other medium that can be used to store desired information.

As will be discussed in detail below, the master computer 103 runs a software application for performing one or more operations according to various examples of the invention. Accordingly, the memory 107 stores software instructions 109A that, when executed, will implement a software application for performing one or more operations. The memory 107 also stores data 109B to be used with the software application. In the illustrated embodiment, the data 109B contains process data that the software application uses to perform the operations, at least some of which may be parallel.

The master computer 103 also includes a plurality of processor units 111 and an interface device 113. The processor units 111 may be any type of processor device that can be programmed to execute the software instructions 109A, but will conventionally be a microprocessor device. For example, one or more of the processor units 111 may be a commercially generic programmable microprocessor, such as Intel® Pentium® or Xeon™ microprocessors, Advanced Micro Devices Athlon™ microprocessors or Motorola 68K/Coldfire® microprocessors. Alternately or additionally, one or more of the processor units 111 may be a custom-manufactured processor, such as a microprocessor designed to optimally perform specific types of mathematical operations. The interface device 113, the processor units 111, the memory 107 and the input/output devices 105 are connected together by a bus 115.

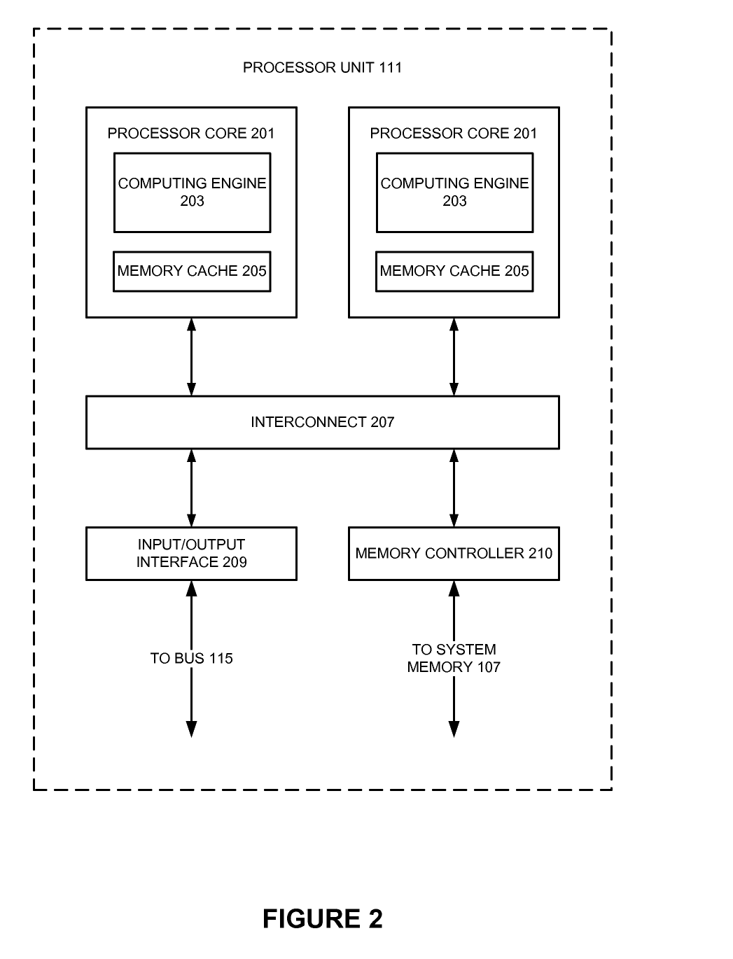

With some implementations of the invention, the master computing device 103 may employ one or more processing units 111 having more than one processor core. Accordingly, FIG. 2 illustrates an example of a multi-core processor unit 111 that may be employed with various embodiments of the invention. As seen in this figure, the processor unit 111 includes a plurality of processor cores 201. Each processor core 201 includes a computing engine 203 and a memory cache 205. As known to those of ordinary skill in the art, a computing engine contains logic devices for performing various computing functions, such as fetching software instructions and then performing the actions specified in the fetched instructions. These actions may include, for example, adding, subtracting, multiplying, and comparing numbers, performing logical operations such as AND, OR, NOR and XOR, and retrieving data. Each computing engine 203 may then use its corresponding memory cache 205 to quickly store and retrieve data and/or instructions for execution.

Each processor core 201 is connected to an interconnect 207. The particular construction of the interconnect 207 may vary depending upon the architecture of the processor unit 201. With some processor cores 201, such as the Cell microprocessor created by Sony Corporation, Toshiba Corporation and IBM Corporation, the interconnect 207 may be implemented as an interconnect bus. With other processor units 201, however, such as the Opteron™ and Athlon™ dual-core processors available from Advanced Micro Devices of Sunnyvale, Calif., the interconnect 207 may be implemented as a system request interface device. In any case, the processor cores 201 communicate through the interconnect 207 with an input/output interface 209 and a memory controller 211. The input/output interface 209 provides a communication interface between the processor unit 201 and the bus 115. Similarly, the memory controller 211 controls the exchange of information between the processor unit 201 and the system memory 107. With some implementations of the invention, the processor units 201 may include additional components, such as a high-level cache memory accessible shared by the processor cores 201.

While FIG. 2 shows one illustration of a processor unit 201 that may be employed by some embodiments of the invention, it should be appreciated that this illustration is representative only, and is not intended to be limiting. For example, some embodiments of the invention may employ a master computer 103 with one or more Cell processors. The Cell processor employs multiple input/output interfaces 209 and multiple memory controllers 211. Also, the Cell processor has nine different processor cores 201 of different types. More particularly, it has six or more synergistic processor elements (SPEs) and a power processor element (PPE). Each synergistic processor element has a vector-type computing engine 203 with 428×428 bit registers, four single-precision floating point computational units, four integer computational units, and a 556 KB local store memory that stores both instructions and data. The power processor element then controls that tasks performed by the synergistic processor elements. Because of its configuration, the Cell processor can perform some mathematical operations, such as the calculation of fast Fourier transforms (FFTs), at substantially higher speeds than many conventional processors.

It also should be appreciated that, with some implementations, a multi-core processor unit 111 can be used in lieu of multiple, separate processor units 111. For example, rather than employing six separate processor units 111, an alternate implementation of the invention may employ a single processor unit 111 having six cores, two multi-core processor units each having three cores, a multi-core processor unit 111 with four cores together with two separate single-core processor units 111, etc.

Returning now to FIG. 1, the interface device 113 allows the master computer 103 to communicate with the servant computers 117A, 117B, 117C . . . 117x through a communication interface. The communication interface may be any suitable type of interface including, for example, a conventional wired network connection or an optically transmissive wired network connection. The communication interface may also be a wireless connection, such as a wireless optical connection, a radio frequency connection, an infrared connection, or even an acoustic connection. The interface device 113 translates data and control signals from the master computer 103 and each of the servant computers 117 into network messages according to one or more communication protocols, such as the transmission control protocol (TCP), the user datagram protocol (UDP), and the Internet protocol (IP). These and other conventional communication protocols are well known in the art, and thus will not be discussed here in more detail.

Each servant computer 117 may include a memory 119, a processor unit 121, an interface device 123, and, optionally, one more input/output devices 125 connected together by a system bus 127. As with the master computer 103, the optional input/output devices 125 for the servant computers 117 may include any conventional input or output devices, such as keyboards, pointing devices, microphones, display monitors, speakers, and printers. Similarly, the processor units 121 may be any type of conventional or custom-manufactured programmable processor device. For example, one or more of the processor units 121 may be commercially generic programmable microprocessors, such as Intel® Pentium® or Xeon™ microprocessors, Advanced Micro Devices Athlon™ microprocessors or Motorola 68K/Coldfire® microprocessors. Alternately, one or more of the processor units 121 may be custom-manufactured processors, such as microprocessors designed to optimally perform specific types of mathematical operations. Still further, one or more of the processor units 121 may have more than one core, as described with reference to FIG. 2 above. For example, with some implementations of the invention, one or more of the processor units 121 may be a Cell processor. The memory 119 then may be implemented using any combination of the computer readable media discussed above. Like the interface device 113, the interface devices 123 allow the servant computers 117 to communicate with the master computer 103 over the communication interface.

In the illustrated example, the master computer 103 is a multi-processor unit computer with multiple processor units 111, while each servant computer 117 has a single processor unit 121. It should be noted, however, that alternate implementations of the invention may employ a master computer having single processor unit 111. Further, one or more of the servant computers 117 may have multiple processor units 121, depending upon their intended use, as previously discussed. Also, while only a single interface device 113 or 123 is illustrated for both the master computer 103 and the servant computers, it should be noted that, with alternate embodiments of the invention, either the computer 103, one or more of the servant computers 117, or some combination of both may use two or more different interface devices 113 or 123 for communicating over multiple communication interfaces.

With various examples of the invention, the master computer 103 may be connected to one or more external data storage devices. These external data storage devices may be implemented using any combination of computer readable media that can be accessed by the master computer 103. The computer readable media may include, for example, microcircuit memory devices such as read-write memory (RAM), read-only memory (ROM), electronically erasable and programmable read-only memory (EEPROM) or flash memory microcircuit devices, CD-ROM disks, digital video disks (DVD), or other optical storage devices. The computer readable media may also include magnetic cassettes, magnetic tapes, magnetic disks or other magnetic storage devices, punched media, holographic storage devices, or any other medium that can be used to store desired information. According to some implementations of the invention, one or more of the servant computers 117 may alternately or additionally be connected to one or more external data storage devices. Typically, these external data storage devices will include data storage devices that also are connected to the master computer 103, but they also may be different from any data storage devices accessible by the master computer 103.

It also should be appreciated that the description of the computer network illustrated in FIG. 1 and FIG. 2 is provided as an example only, and it not intended to suggest any limitation as to the scope of use or functionality of alternate embodiments of the invention.

### Electronic Design Automation Verification

As previously noted, various embodiments of the invention are related to electronic design automation. In particular, various implementations of the invention may be used to improve the operation of electronic design automation software tools that identify, verify and/or modify design data for manufacturing a microdevice, such as a microcircuit. As used herein, the terms “design” and “design data” are intended to encompass data describing an entire microdevice, such as an integrated circuit device or micro-electromechanical system (MEMS) device. This term also is intended to encompass a smaller set of data describing one or more components of an entire microdevice, however, such as a layer of an integrated circuit device, or even a portion of a layer of an integrated circuit device. Still further, the terms “design” and “design data” also are intended to encompass data describing more than one microdevice, such as data to be used to create a mask or reticle for simultaneously forming multiple microdevices on a single wafer. It should be noted that, unless otherwise specified, the term “design” as used herein is intended to encompass any type of design, including both a physical layout design and a logical design.

Designing and fabricating microcircuit devices involve many steps during a ‘design flow’ process. These steps are highly dependent on the type of microcircuit, its complexity, the design team, and the fabricator or foundry that will manufacture the microcircuit from the design. Several steps are common to most design flows, however. First, a design specification is modeled logically, typically in a hardware design language (HDL). Once a logical design has been created, various logical analysis processes are performed on the design to verify its correctness. More particularly, software and hardware “tools” verify that the logical design will provide the desired functionality at various stages of the design flow by running software simulators and/or hardware emulators, and errors are corrected. For example, a designer may employ one or more functional logic verification processes to verify that, given a specified input, the devices in a logical design will perform in the desired manner and provide the appropriate output.

In addition to verifying that the devices in a logic design will provide the desired functionality, some designers may employ a design logic verification process to verify that the logical design meets specified design requirements. For example, a designer may create rules such as, e.g., every transistor gate in the design must have an electrical path to ground that passes through no more than three other devices, or every transistor that connects to a specified power supply also must be connected to a corresponding ground node, and not to any other ground node. A design logic verification process then will determine if a logical design complies with specified rules, and identify occurrences where it does not.

After the logical design is deemed satisfactory, it is converted into physical design data by synthesis software. This physical design data or “layout” design data may represent, for example, the geometric elements that will be written onto a mask used to fabricate the desired microcircuit device in a photolithographic process at a foundry. For conventional mask or reticle writing tools, the geometric elements typically will be polygons of various shapes. Thus, the layout design data usually includes polygon data describing the features of polygons in the design. It is very important that the physical design information accurately embody the design specification and logical design for proper operation of the device. Accordingly, after it has been created during a synthesis process, the physical design data is compared with the original logical design schematic in a process sometimes referred to as a “layout-versus-schematic” (LVS) process.

Once the correctness of the logical design has been verified, and geometric data corresponding to the logical design has been created in a layout design, the geometric data then may be analyzed. For example, because the physical design data is employed to create masks used at a foundry, the data must conform to the foundry's requirements. Each foundry specifies its own physical design parameters for compliance with their processes, equipment, and techniques. Accordingly, the design flow may include a process to confirm that the design data complies with the specified parameters. During this process, the physical layout of the circuit design is compared with design rules in a process commonly referred to as a “design rule check” (DRC) process. In addition to rules specified by the foundry, the design rule check process may also check the physical layout of the circuit design against other design rules, such as those obtained from test chips, general knowledge in the industry, previous manufacturing experience, etc.

With modern electronic design automation design flows, a designer may additionally employ one or more “design-for-manufacture” (DFM) software tools. As previously noted, design rule check processes attempt to identify, e.g., elements representing structures that will almost certainly be improperly formed during a manufacturing process. “Design-For-Manufacture” tools, however, provide processes that attempt to identify elements in a design representing structures with a significant likelihood of being improperly formed during the manufacturing process. A “design-for-manufacture” process may additionally determine what impact the improper formation of the identified elements will have on the yield of devices manufactured from the circuit design, and/or modifications that will reduce the likelihood that the identified elements will be improperly formed during the manufacturing process. For example, a “design-for-manufacture” (DFM) software tool may identify wires that are connected by only a single via, determine the yield impact for manufacturing a circuit from the design based upon the probability that each individual single via will be improperly formed during the manufacturing process, and then identify areas where redundant vias can be formed to supplement the single vias.

It should be noted that, in addition to “design-for-manufacture,” various alternate terms are used in the electronic design automation industry. Accordingly, as used herein, the term “design-for-manufacture” or “design-for-manufacturing” is intended to encompass any electronic design automation process that identifies elements in a design representing structures that may be improperly formed during the manufacturing process. Thus, “design-for-manufacture” (DFM) software tools will include, for example, “lithographic friendly design” (LFD) tools that assist designers to make trade-off decisions on how to create a circuit design that is more robust and less sensitive to lithographic process windows. They will also include “design-for-yield” (DFY) electronic design automation tools, “yield assistance” electronic design automation tools, and “chip cleaning” and “design cleaning” electronic design automation tools.

After a designer has used one or more geometry analysis processes to verify that the physical layout of the circuit design is satisfactory, the designer may then perform one or more simulation processes to simulate the operation of a manufacturing process, in order to determine how the design will actually be realized by that particular manufacturing process. A simulation analysis process may additionally modify the design to address any problems identified by the simulation (i.e., to verify that the design will be reliably manufactured during a photolithographic manufacturing process). For example, some design flows may employ one or more processes to simulate the image formed by the physical layout of the circuit design during a photolithographic process, and then modify the layout design to improve the resolution of the image that it will produce during a photolithography process.

These resolution enhancement techniques (RET) may include, for example, modifying the physical layout using optical proximity correction (OPC) or by the addition of sub-resolution assist features (SRAF). Other simulation analysis processes may include, for example, phase shift mask (PSM) simulation analysis processes, etch simulation analysis processes and planarization simulation analysis processes. Etch simulation analysis processes simulate the removal of materials during a chemical etching process, while planarization simulation processes simulate the polishing of the circuit's surface during a chemical-mechanical etching process. These simulation analysis processes may identify, for example, regions where an etch or polishing process will not leave a sufficiently planar surface. These simulation analysis processes may then modify the physical layout design to, e.g., include more geometric elements in those regions to increase their density.

It should be appreciated that various design flows may repeat one or more processes in any desired order. Thus, with some design flows, geometric analysis processes can be interleaved with simulation analysis processes and/or logical analysis processes. For example, once the physical layout of the circuit design has been modified using resolution enhancement techniques, then a design rule check process or design-for-manufacturing process may be performed on the modified layout, Further, these processes may be alternately repeated until a desired degree of resolution for the design is obtained. Similarly, a design rule check process and/or a design-for-manufacturing process may be employed after an optical proximity correction process, a phase shift mask simulation analysis process, an etch simulation analysis process or a planarization simulation analysis process. Examples of electronic design tools that employ one or more of the logical analysis processes, geometry analysis processes or simulation analysis processes discussed above are described in U.S. Pat. No. 6,230,299 to McSherry et al., issued May 8, 2001, U.S. Pat. No. 6,249,903 to McSherry et al., issued Jun. 19, 2001, U.S. Pat. No. 6,339,836 to Eisenhofer et al., issued Jan. 15, 2002, U.S. Pat. No. 6,397,372 to Bozkus et al., issued May 28, 2002, U.S. Pat. No. 6,415,421 to Anderson et al., issued Jul. 2, 2002, and U.S. Pat. No. 6,425,113 to Anderson et al., issued Jul. 23, 2002, each of which are incorporated entirely herein by reference.

### Hierarchical Organization of Design Data

The design of a new integrated circuit may include the interconnection of millions of transistors, resistors, capacitors, or other electrical structures into logic circuits, memory circuits, programmable field arrays, and other circuit devices. In order to allow a computer to more easily create and analyze these large data structures (and to allow human users to better understand these data structures), they are often hierarchically organized into smaller data structures, typically referred to as “cells.” Thus, for a microprocessor or flash memory design, all of the transistors making up a memory circuit for storing a single bit may be categorized into a single “bit memory” cell. Rather than having to enumerate each transistor individually, the group of transistors making up a single-bit memory circuit can thus collectively be referred to and manipulated as a single unit. Similarly, the design data describing a larger 16-bit memory register circuit can be categorized into a single cell. This higher level “register cell” might then include sixteen bit memory cells, together with the design data describing other miscellaneous circuitry, such as an input/output circuit for transferring data into and out of each of the bit memory cells. Similarly, the design data describing a 128 kB memory array can then be concisely described as a combination of only 64,000 register cells, together with the design data describing its own miscellaneous circuitry, such as an input/output circuit for transferring data into and out of each of the register cells. Of course, while the above-described example is of design data organized hierarchically based upon circuit structures, circuit design data may alternately or additionally be organized hierarchically according to any desired criteria including, for example, a geographic grid of regular or arbitrary dimensions (e.g., windows), a memory amount available for performing operations on the design data, design element density, etc.

By categorizing microcircuit design data into hierarchical cells, large data structures can be processed more quickly and efficiently. For example, a circuit designer typically will analyze a design to ensure that each circuit feature described in the design complies with design rules specified by the foundry that will manufacture microcircuits from the design. With the above example, instead of having to analyze each feature in the entire 128 kB memory array, a design rule check process can analyze the features in a single bit cell. The results of the check will then be applicable to all of the single bit cells. Once it has confirmed that one instance of the single bit cells complies with the design rules, the design rule check process then can complete the analysis of a register cell simply by analyzing the features of its additional miscellaneous circuitry (which may itself be made of up one or more hierarchical cells). The results of this check will then be applicable to all of the register cells. Once it has confirmed that one instance of the register cells complies with the design rules, the design rule check software application can complete the analysis of the entire 128 kB memory array simply by analyzing the features of the additional miscellaneous circuitry in the memory array. Thus, the analysis of a large data structure can be compressed into the analyses of a relatively small number of cells making up the data structure.

### Software Tools for Simulation, Verification or Modification of a Circuit Layout

To facilitate an understanding of various embodiments of the invention, one such software tool for automatic design automation, directed to the analysis and modification of a design for an integrated circuit, will now be generally described. As previously noted, the terms “design” and “design data” are used herein to encompass data describing an entire microdevice, such as an integrated circuit device or micro-electromechanical system (MEMS) device. These terms also are intended, however, to encompass a smaller set of data describing one or more components of an entire microdevice, such as a layer of an integrated circuit device, or even a portion of a layer of an integrated circuit device. Still further, the terms “design” and “design data” also are intended to encompass data describing more than one microdevice, such as data to be used to create a mask or reticle for simultaneously forming multiple microdevices on a single wafer. As also previously noted, unless otherwise specified, the term “design” as used herein is intended to encompass any type of design, including both physical layout designs and logical designs.

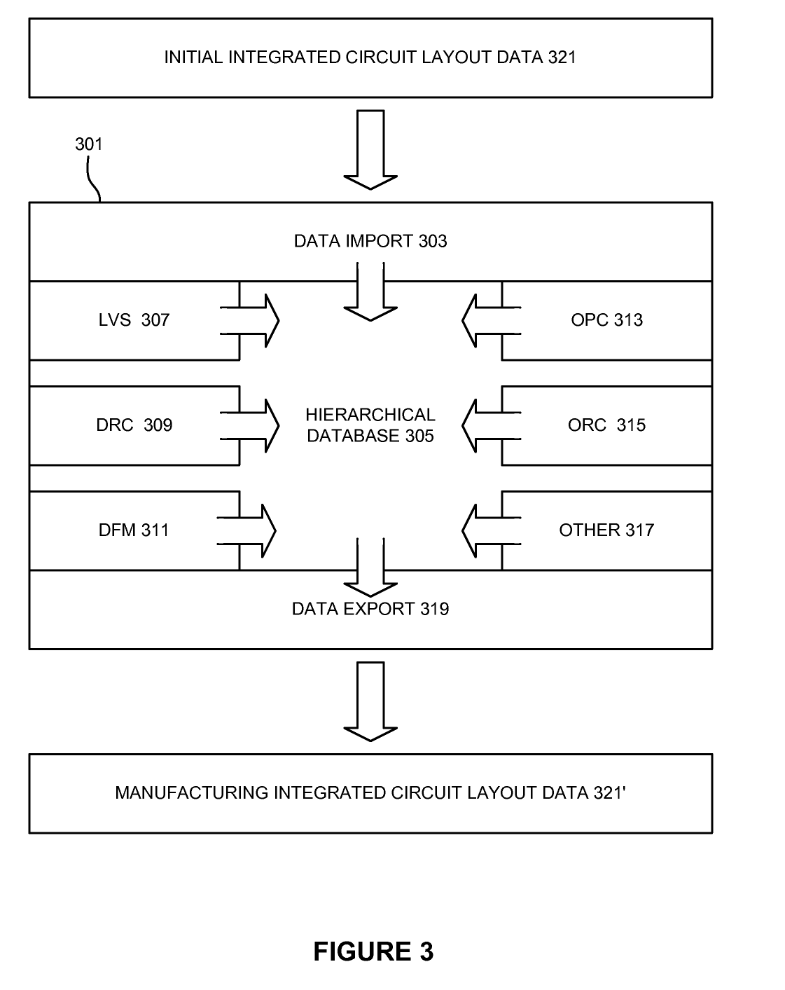

As seen in FIG. 3, an analysis tool 301, which may be implemented by a variety of different software applications, includes a data import module 303 and a hierarchical database 305. The analysis tool 301 also includes a layout-versus-schematic (LVS) verification module 307, a design rule check (DRC) module 309, a design-for-manufacturing (DFM) module 311, an optical proximity correction (OPC) module 313, and an optical proximity rule check (ORC) module 315. The analysis tool 301 may further include other modules 317 for performing additional functions as desired, such as a phase shift mask (PSM) module (not shown), an etch simulation analysis module (not shown) and/or a planarization simulation analysis module (not shown). The tool 301 also has a data export module 319. One example of such an analysis tool is the Calibre family of software applications available from Mentor Graphics Corporation of Wilsonville, Oreg.

Initially, the tool 301 receives data 321 describing a physical layout design for an integrated circuit. The layout design data 321 may be in any desired format, such as, for example, the Graphic Data System II (GDSII) data format or the Open Artwork System Interchange Standard (OASIS) data format proposed by Semiconductor Equipment and Materials International (SEMI). Other formats for the data 321 may include an open source format named Open Access, Milkyway by Synopsys, Inc., and EDDM by Mentor Graphics, Inc. The layout data 321 includes geometric elements for manufacturing one or more portions of an integrated circuit device. For example, the initial integrated circuit layout data 321 may include a first set of polygons for creating a photolithographic mask that in turn will be used to form an isolation region of a transistor, a second set of polygons for creating a photolithographic mask that in turn will be used to form a contact electrode for the transistor, and a third set of polygons for creating a photolithographic mask that in turn will be used to form an interconnection line to the contact electrode. The initial integrated circuit layout data 321 may be converted by the data import module 303 into a format that can be more efficiently processed by the remaining components of the tool 301.

Once the data import module 303 has converted the original integrated circuit layout data 321 to the appropriate format, the layout data 321 is stored in the hierarchical database 305 for use by the various operations executed by the modules 305-317. Next, the layout-versus-schematic module 307 checks the layout design data 321 in a layout-versus-schematic process, to verify that it matches the original design specifications for the desired integrated circuit. If discrepancies between the layout design data 321 and the logical design for the integrated circuit are identified, then the layout design data 321 may be revised to address one or more of these discrepancies. Thus, the layout-versus-schematic process performed by the layout-versus-schematic module 307 may lead to a new version of the layout design data with revisions. According to various implementations of the invention tool 301, the layout data 321 may be manually revised by a user, automatically revised by the layout-versus-schematic module 307, or some combination thereof.

Next, the design rule check module 309 confirms that the verified layout data 321 complies with defined geometric design rules. If portions of the layout data 321 do not adhere to or otherwise violate the design rules, then the layout data 321 may be modified to ensure that one or more of these portions complies with the design rules. The design rule check process performed by the design rule check module 309 thus also may lead to a new version of the layout design data with various revisions. Again, with various implementations of the invention tool 301, the layout data 321 may be manually modified by a user, automatically modified by the design rule check module 309, or some combination thereof.

The modified layout data 321 is then processed by the design for manufacturing module 311. As previously noted, a “design-for-manufacture” processes attempts to identify elements in a design representing structures with a significant likelihood of being improperly formed during the manufacturing process. A “design-for-manufacture” process may additionally determine what impact the improper formation of the identified structures will have on the yield of devices manufactured from the circuit design, and/or modifications that will reduce the likelihood that the identified structures may be improperly formed during the manufacturing process. For example, a “design-for-manufacture” (DFM) software tool may identify wires that are connected by single vias, determine the yield impact based upon the probability that each individual single via will be improperly formed during the manufacturing process, and then identify areas where redundant visa can be formed to supplement the single vias.

The processed layout data 321 is then passed to the optical proximity correction module 313, which corrects the layout data 321 for manufacturing distortions that would otherwise occur during the lithographic patterning. For example, the optical proximity correction module 313 may correct for image distortions, optical proximity effects, photoresist kinetic effects, and etch loading distortions. The layout data 321 modified by the optical proximity correction module 313 then is provided to the optical process rule check module 315

The optical process rule check module 315 (more commonly called the optical rules check module or ORC module) ensures that the changes made by the optical proximity correction module 313 are actually manufacturable, a “downstream-looking” step for layout verification. This compliments the “upstream-looking” step of the LVS performed by the LVS module 307 and the self-consistency check of the DRC process performed by the DRC module 309, adding symmetry to the verification step. Thus, each of the processes performed by the design for manufacturing process 311, the optical proximity correction module 313, and the optical process rule check module 315 may lead to a new version of the layout design data with various revisions.

As previously noted, other modules 317 may be employed to perform alternate or additional manipulations of the layout data 321, as desired. For example, some implementations of the tool 301 may employ, for example, a phase shift mask module. As previously discussed, with a phase-shift mask (PSM) analysis (another approach to resolution enhancement technology (RET)), the geometric elements in a layout design are modified so that the pattern they create on the reticle will introduce contrast-enhancing interference fringes in the image. The tool 301 also may alternately or additionally employ, for example, an etch simulation analysis processes or a planarization simulation analysis processes. The process or processes performed by each of these additional modules 317 may also lead to the creation of a new version of the layout data 321 that includes revisions.

After all of the desired operations have been performed on the initial layout data 321, the data export module 319 converts the processed layout data 321 into manufacturing integrated circuit layout data 323 that can be used to form one or more masks or reticules to manufacture the integrated circuit (that is, the data export module 319 converts the processed layout data 321 into a format that can be used in a photolithographic manufacturing process). Masks and reticles typically are made using tools that expose a blank reticle or mask substrate to an electron or laser beam (or to an array of electron beams or laser beams), but most mask writing tools are able to only “write” certain kinds of polygons, however, such as right triangles, rectangles or other trapezoids. Moreover, the sizes of the polygons are limited physically by the maximum beam (or beam array) size available to the tool.

Accordingly, the data export module 319 may “fracture” larger geometric elements in the layout design, or geometric elements that are not right triangles, rectangles or trapezoids (which typically are a majority of the geometric elements in a layout design) into the smaller, more basic polygons that can be written by the mask or reticle writing tool. Of course, the data export module 319 may alternately or additionally convert the processed layout data 321 into any desired type of data, such as data for use in a synthesis process (e.g., for creating an entry for a circuit library), data for use in a place-and-route process, data for use in calculating parasitic effects, etc. Further, the tool 301 may store one or more versions of the layout 321 containing different modifications, so that a designer can undo undesirable modifications. For example, the hierarchical database 305 may store alternate versions of the layout data 321 created during any step of the process flow between the modules 307-317.

### Virtual Flat Design Traversal Tool

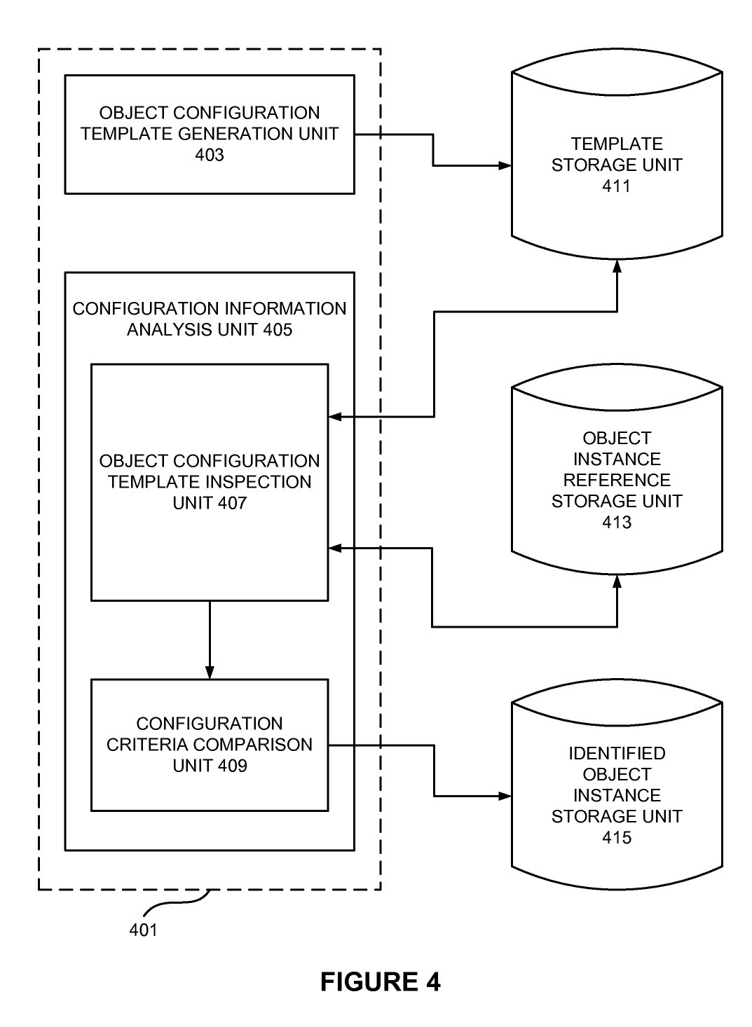

FIG. 4 illustrates a virtual flat design traversal tool 401 that may be implemented according to various embodiments of the invention. As seen in this figure, the virtual flat design traversal tool 401 includes an object configuration template generation unit 403 and a configuration information analysis unit 405. The configuration information analysis unit 405 in turn may include an object configuration template inspection unit 407 and a configuration criteria comparison unit 409. Each of the object configuration template generation unit 403, the configuration information analysis unit 405, the object configuration template inspection unit 407 and the configuration criteria comparison unit 409 may be implemented by one or more programmable computers, such as the computer 101 shown in FIG. 1, executing programming instructions to thereby transform the one or more programmable computers, such as the computer 101 shown in FIG. 1. into special-purpose devices for performing the specific functions associated with these units. Correspondingly, with alternate embodiments of the invention, each of the object configuration template generation unit 403, the configuration information analysis unit 405, the object configuration template inspection unit 407 and the configuration criteria comparison unit 409 may be implemented by software instructions, stored on a computer-readable medium, for programming a programmable computer to perform the functions these units. The computer-readable medium may be, for example, a magnetic storage device, an optical storage device, a “punched” surface type device, or a solid state storage device.

As also seen in FIG. 4, the virtual flat design traversal tool 401 interacts with a template storage unit 411, an object instance reference storage unit 413, and an identified object instance storage unit 415. Each of these storage units 411-413 may be implemented by any conventional data storage device, such as a magnetic storage device, an optical storage device, a “punched” surface type device, or a solid state storage device. Also, the data within each of the storage units 411-413 may be organized according to any conventional data organizational scheme. It should be appreciated that, while each of the storages units 411-415 are shown as separate entities for ease of explanation, the storage units 411-415 may be combined, subdivided, or repartitioned in any desired manner. Further, some or all of one or more of the storage units 411-415 may be combined with other storage units, such as a storage unit for a database such as the hierarchical database 305 illustrated in FIG. 3.

As will be discussed in more detail below, the object configuration template generation unit 403 will examine hierarchical circuit design data to create object configuration templates reflecting configuration information described in the hierarchical circuit design data. For example, the object configuration template generation unit 403 may generate an object configuration template for each cell in the design data, such that the object configuration template will contain the object configuration information for the objects associated with its corresponding cell. With various implementations of the invention, the object configure information will include both template generic configuration information and instance specific configuration information. The template generic configuration information is configuration information that is common to all instantiations of the corresponding cell in the hierarchical circuit design data. The instance specific configuration information is then configuration information that is particular to one or more specific instantiations of the corresponding cell in the hierarchical circuit design data.

After the object configuration template generation unit 403 has generated the object configuration templates, the configuration information analysis unit 405 will use the object configuration information contained in the object configuration templates to identify objects having configuration data that match defined configuration criteria. As will be discussed in more detail below, the defined configuration criteria may be criteria specified by a user, such as a designer or an electronic design automation process. The object configuration template inspection unit 407 examines the configuration information in each template, to determine if a target object specified in the configuration criteria is associated with its corresponding cell. If the target object is associated with the corresponding cell, then the object configuration template inspection unit 407 inspects the object configuration template to retrieve the configuration information for each instance of that object associated with the corresponding cell. The configuration criteria comparison unit 409 will then determine if any of the retrieved configuration information matches the configuration criteria. If the retrieved configuration information for an instance of an object matches the configuration criteria, then identification information for that object instance is provided to the identified object instance storage unit 415 for future use.

Depending upon the configuration criteria, the configuration information analysis unit 405 may be able to obtain all of the relevant configuration information for each object instance from the template generic configuration information. In other cases, however, the instance specific configuration information for an object instance may identify one or more other cells with which the object instance is associated. The object configuration template inspection unit 407 will then use the object configuration information in the object configuration templates for those other cells to obtain all of the relevant configuration information for the object instance. If, for example, the object instance also is associated with a child cell, then the template inspection unit 407 may retrieve the relevant configuration information for the object instance from the object configuration template corresponding to that child cell. Alternately, if the object instance also is associated with a parent cell, then the object configuration template inspection unit 407 may store a reference to the object instance in the object instance reference storage unit 413. The object configuration template inspection unit 407 can then continue the inspection of the relevant configuration information for the object instance when the template for that parent cell subsequently is analyzed.

### Virtual Flat Traversal of a Hierarchical Circuit Design

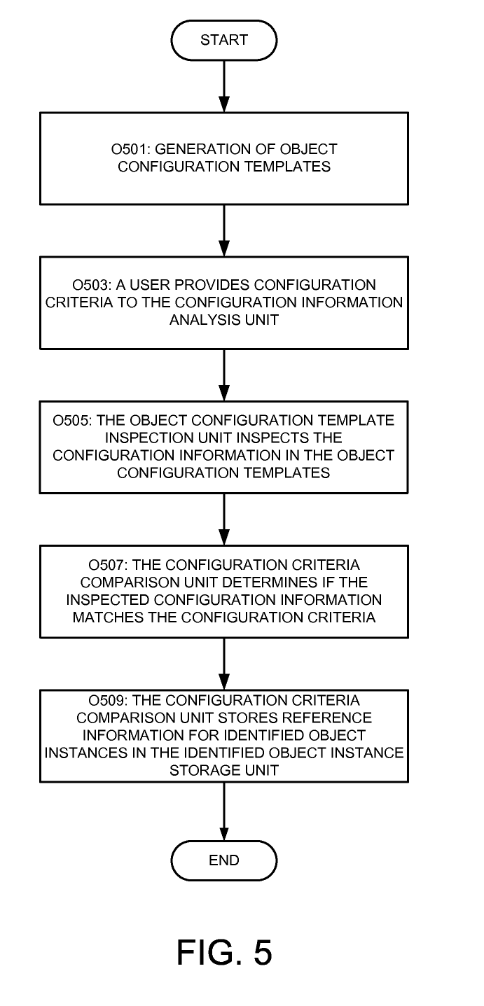

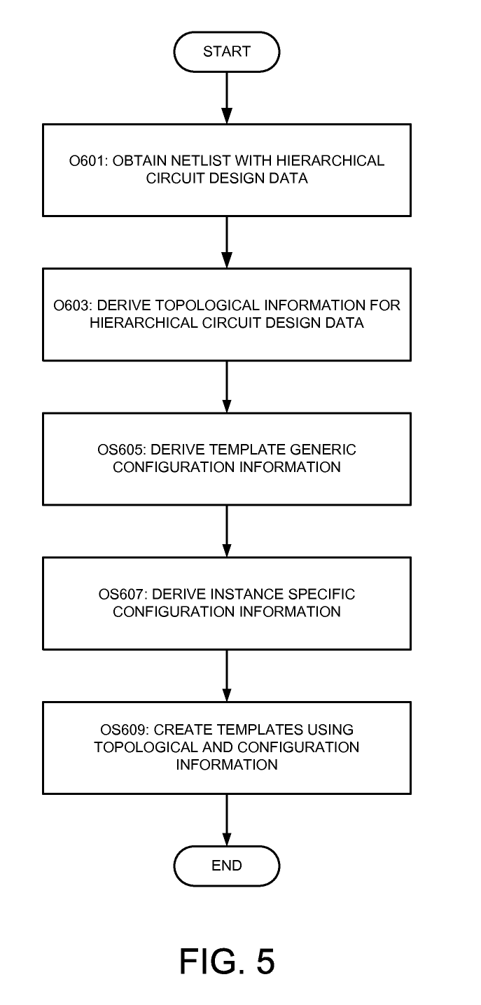

FIGS. 5 and 6 illustrate flowcharts showing virtual traversal methods of a hierarchical circuit design that may be employed according to various embodiments of the invention. For ease of understanding, these methods will be described with reference to the virtual flat design traversal tool 401 illustrated in FIG. 4. It should be appreciated, however, that alternate implementations of a virtual flat design traversal tool may be used to perform the virtual traversal methods shown in FIGS. 5 and 6. Likewise, the virtual flat design traversal tool 401 may be employed to perform virtual traversal methods according to various embodiments of the invention other than those explicitly shown in FIGS. 5 and 6.

Initially, in operation 501, the object configuration template generation unit 403 will generate object configuration templates corresponding to hierarchical cells in hierarchical circuit design data. The generation of object configuration templates will be discussed in more detail with regard to the flowchart illustrated in FIG. 6.

As seen in this figure, with various embodiments of the invention, the object configuration template generation unit 403 will begin the process of generating object configuration templates in operation 601 by obtaining a netlist containing the hierarchical circuit design data. With some implementations of the invention, for example, a temporary netlist may be generated from hierarchical layout design data using, e.g., a conventional layout-versus-schematic electronic design automation process. With still other examples of the invention, however, a netlist may be provided from another source. For example, some implementations may be employed to identify objects native to a netlist rather than to layout design data, in which case the original netlist could be employed to generate the object configuration templates. Of course, still other implementations of the invention may omit operation 601, and obtain configuration information directly from other types of hierarchical circuit design data, such as layout d.

Next, in operation 603, the object configuration template generation unit 403 derives the topological information for the hierarchical circuit design data. As will be appreciated by those of ordinary skill in the art, this topological information will reflect the hierarchical relationship between the cells in the circuit design. More particularly, the topological information will indicate the placement of child cells within parent cells. For example, the topological information might indicate that a top level cell, named “Top Cell,” contains two instantiations of a child cell named “Cell A,” and three instantiations of a child cell named “Cell B,” which child cell in turn contains four instantiations of a child cell named “Cell B1.” With various implementations of the invention, the topological information may be derived from traversing the netlist. Of course, with still other implementations of the invention, the topological information may be derived from other forms of the hierarchical circuit design data (e.g., layout design data), or simply provided to the object configuration template generation unit 403 from an outside source, such as a prior electronic design automation process.

In operation 605, the object configuration template generation unit 403 derives template generic configuration information for each cell in the hierarchical circuit design data. With various implementations of the invention, each object configuration template will correspond with only a single hierarchical cell. For these implementations, the template generic configuration information will include configuration information common to all instances of the corresponding hierarchical cell.

Typically, the configuration information will include objects within the cell and connection information for those objects. With some implementations of the invention, for example, the template generic configuration information will include a graph representing the connection of all of the circuit devices within the cell. The category of circuit devices may include any desired circuit devices, such as transistors, diodes, resistors, capacitors, inductors, and memristors. Of course, still other implementations of the invention may use any other desired data structure to represent the connectivity of circuit devices within a cell.

The configuration information may also include other information associated with the cell, such as characteristics of objects within the cell, properties associated with objects within the cell, or characteristics of or properties associated with the cell itself For example, if the cell includes a circuit device object such as a transistor, then the object characteristics may be the width of transistor, the length of the transistor, etc. If the cell includes one or more other cells as objects, then the object characteristics may include the name or other salient characteristics of the cell. With regard to properties associated with an object, properties of this type are described in, e.g., U.S. Patent Publication No. US2008/0168410, entitled “Properties In Electronic Design Automation,” published Jul. 10, 2008 and naming Fedor G. Pikus and Ellis Cohen as inventors, which patent publication is incorporated entirely herein by reference.

In some implementations of the invention, a template may be associated with two or more hierarchical cells in the circuit design data. For example, a first cell may have a particular connection arrangement of circuit devices. A second cell may then have a similar connection arrangement of circuit devices, differing from the first cell in only a few device connections. A single object configuration template may then be configured to correspond to both hierarchical cells for convenience. The object configuration template may, for example, include template generic configuration information containing two graphs, with one graph representing the connection arrangement of the first cell and the other graph representing the connection arrangement of the second cell. Alternately, the template generic configuration information may contain a single graph representing the circuit device connections common to both cells, with additional variation information describing the device connection differences between the cells.

In operation 607, for each object configuration template, the object configuration template generation unit 403 derives the instance specific configuration information for each instance of the cell (or cells) corresponding to that template. Again, the configuration information may include both connectivity information and other information associated with an instance of the corresponding cell. With various implementations of the invention, the instance specific configuration information for an instance of a cell will include connection information for the boundary of that cell instance. For example, if the instance specific configuration information is derived from a netlist, then the instance specific configuration information will include the netlist ports through which that cell instance is connected to child or parent cells. The instance specific configuration information may be implemented as a “signature,” associated with at least one instance of the corresponding cell. If two or more instances of the cell have the same instance specific configuration information, then a single signature may be associated with each of the indistinguishable cell instances.

The object configuration template generation unit 403 creates object configuration templates using the derived topological and configuration information in operation 609, and stores the object configuration templates in the template storage unit 411. Accordingly, after the object configuration template generation unit 403 has completed the operations shown in FIG. 5, each cell in the hierarchical circuit design data will have a corresponding object configuration template stored in the template storage unit 411. Moreover, that object configuration template will include template generic configuration information common to all instances of that cell in the hierarchical circuit design. That object configuration template also will include instance specific configuration information, such as a signature, particular to each instance of the cell in the hierarchical circuit design data.

It should be appreciated that, while operations 601-609 are illustrated in a specific order, these operations can be performed in any desired order, and one or more of these operations may be performed concurrently. For example, while the operation 609 is shown as a distinct operation from operations 603-605, with various implementations of the invention operation 609 may be performed concurrently with one or more of operations 603-605 as topological or configuration information is derived by those operations. Still further, it should be appreciated that one or more of these operations may be omitted if the desired information can be obtained from another source. Still further, one or more of the operations 601-607 may be performed by a unit other than the object configuration template generation unit 403. For example, with some implementations of the invention, the object configuration template generation unit 403 may directly or indirectly employ a separate electronic design automation tool to obtain a temporary netlist by performing a layout-versus-schematic operation.

Returning now to FIG. 5, in operation 503 a user provides configuration criteria to the configuration information analysis unit 405. The user may be, for example, a human designer that provides configuration criteria to the configuration information analysis unit 405 via a keyboard or graphical user interface. Alternately, the user may be a separate electronic design automation tool that provides configuration criteria via a data file or other electronic data transmission. The configuration criteria will describe one or more particular circuit features that the user wishes to identify in the hierarchical circuit design data.

The configuration criteria usually will contain at least one object type and configuration information associated with that object type. One example of configuration criteria may specify a search for NPN-type transistors connected in parallel to three resistors having values of 10Ω, 200Ω, and 500Ω, respectively. In this example, the object type would be NPN-type transistors, and the configuration information would be parallel connections to three resistors of the stated values. Some embodiments of the invention may additionally permit configuration criteria having multiple object types and multiple configuration criteria. For example, some implementations of the invention may allow a user to specify a compound search, such as a search for NPN-type transistors connected in parallel to three resistors having values of 10Ω, 200Ω, and 500Ω, respectively, where the 500Ω is connected in turn to a PNP-type transistor having a width of 100 μm. Some implementations of the invention may alternately or additionally allow a user to specify an alternate search, such as a search for NPN-type transistors connected in parallel to three resistors having values of 10Ω, 200Ω, and 500Ω, respectively, or connected in parallel to three resistors having values of 20Ω, 400Ω, and 1000Ω, respectively. Still further some implementations of the invention may allow a user to specify a search with alternate object types, such as a search for NPN-type transistors or diodes connected in parallel to three resistors having values of 10Ω, 200Ω, and 500Ω, respectively, or a search for NPN-type transistors or diodes connected in parallel to three resistors having values of 10Ω, 200Ω, and 500Ω, or connected in parallel to three resistors having values of 20Ω, 400Ω, and 1000Ω, respectively.

In response to the configuration criteria, in operation 505 the object configuration template inspection unit 407 inspects the configuration information in the object configuration templates. Then, in operation 507, the configuration criteria comparison unit 409 determines if the inspected configuration information matches the configuration criteria. If an instance of an object matches the specified configuration criteria, then in operation 509 the configuration criteria comparison unit 409 stores reference information for that object instance in the identified object instance storage unit 415.

With some implementations, the object configuration template inspection unit 407 will examine the object configuration templates in a “bottom-up” fashion. That is, the object configuration template inspection unit 407 will first begin inspecting the object configuration templates corresponding to the cells in the circuit design having the lowest hierarchical value (i.e., the cells with no child cells). With these implementations, the object configuration template inspection unit 407 may, for example, instantiate an iterator that first inspects the template generic configuration information. For example, if the search criteria specifies a search for NPN-type transistors connected in parallel to three resistors having values of 10Ω, 200Ω, and 500Ω, respectively, then the iterator will first inspect the template generic configuration information and the configuration criteria comparison unit 409 will determine if the template generic configuration information contains NPN-type transistors connected in parallel to three resistors having the specified value.

If the template generic configuration information does indicate that the cell includes one or more NPN-type transistors connected in parallel to three resistors of the specified values, then the configuration criteria comparison unit 409 will determine that each instance of these transistors matches the configuration criteria. Accordingly, the configuration criteria comparison unit 409 will store reference information for those instances in the identified object instance storage unit 415. The reference information may any desired reference information. For example, the reference information for an object instance may be all of the relevant information for that object instance. Alternately, the reference information may simply be a pointer to that object instance in the circuit design data.

With some implementations of the invention, the object configuration template inspection unit 407 may operate independently of the configuration criteria comparison unit 409. With these implementations of the invention, the object configuration template inspection unit 407 will inspect all of the configuration information in a template and simply relay it to the configuration criteria comparison unit 409. With still other implementations of the invention, however, the configuration criteria comparison unit 409 may operate in tandem with (or be incorporated entirely into) the object configuration template inspection unit 407. With these implementations of the invention, the object configuration template inspection unit 407 may only selectively inspect the configuration information in a template. For example, the template generic configuration information may include a graph representing the connectivity arrangement of circuit devices within the corresponding cell, as previously noted. If the configuration criteria specify NPN-type transistors connected in parallel to three resistors of the specified values, then the iterator may only inspect the graph by starting at nodes corresponding to NPN-type transistors, ignoring all other nodes (unless they are connected to a node corresponding to a NPN-type transistor).

With these implementations of the invention, the object configuration template inspection unit 407 and configuration criteria comparison unit 409 may be able to determine that all of the objects that can match the configuration criteria are contained within the template generic configuration information. In response, the object configuration template inspection unit 407 will omit inspecting the instance specific configuration information, and begin inspecting the next object configuration template. Also, the configuration criteria comparison unit 409 will identify each instance of the objects in the cell matching the configuration criteria, and provide reference information for these object instances to the identified object instance storage unit 415.

In some situations, however, the configuration criteria comparison unit 409 will determine that one or more objects in the corresponding cell is a “prospective” object that might match the configuration criteria. For example, if the configuration criteria specifies NPN-type transistors connected in parallel to three resistors of particular values, the template generic configuration information may include an NPN-type transistor connected to a single resistor having one of the stated values. Further, the template generic configuration information may indicate that the NPN-transistor has two additional parallel connections to some device outside of the boundary of the corresponding cell.

In these situations, the iterator instantiated by the object configuration template inspection unit 407 will examine the instance specific configuration information to determine to what the prospective object is actually connected in each instance of the corresponding cell. (Of course, if the object configuration template inspection unit 407 is operating independently of the configuration criteria comparison unit 409, it will inspect the instance specific configuration information in any case.) As previously noted, the instance specific configuration information may contain information describing connection information, such as netlist ports, for connections passing through the boundary of the corresponding cell. For each cell instantiation, the iterator will determine if the prospective object is connected through the cell boundary to an object in a child cell, to an object in a parent, or to both.

If the prospective object is connected to an object in a child cell, then, using the topological information discussed above, the iterator will reference the object configuration template corresponding to that child cell for the additional configuration information. With some implementations, the iterator will inspect the configuration information in object configuration template for the child cell to determine if the configuration information relevant to the prospective object matches the configuration criteria. With still other implementations of the invention, however, the iterator may retrieve the relevant configuration information from the other object configuration template, and temporarily combine it with the configuration information in the object configuration template corresponding to the parent cell in order for the configuration criteria comparison unit 409 to determine if the prospective object complies with the configuration criteria. In some instances, the configuration information in the object configuration template for the child cell may itself lead to a connection in a grandchild cell. It should be appreciated that, with various embodiments of the invention, the iterator will be configured to inspect object configuration templates for as many generations of child cells as necessary to obtain the relevant configuration information for a prospective object.

If the prospective object is connected to an object in a parent cell, then the iterator will not reference the object configuration template for the parent cell. Instead, after the iterator has inspected all of the relevant information in the current object configuration template and the object configuration templates for any child cells associated with the prospective object, the object configuration template inspection unit 407 will store a reference to the prospective object in the object instance reference storage unit 413. More particularly, the object configuration template inspection unit 407 will save a reference to the prospective object in the object instance reference storage unit 413 in a manner that associates the prospective object with the object configuration template of the parent cell using. The association may be made using any desired technique including for example, storing an object configuration template name, storing the reference to the prospective object in a specific memory location, etc.

As previously noted, with various implementations of the invention, the object configuration template inspection unit 407 will inspect each object configuration template for objects that match the specified configuration criteria. (It should be appreciated that some implementations of the invention may allow a user to “filter” some cells from a search for matching configuration criteria in advance, thereby omitting the corresponding object configuration templates from an initial inspection by the object configuration template inspection unit 407.) In addition to inspecting the template generic configuration information and the instance specific configuration information for an object configuration template, the object configuration template inspection unit 407 also will inspect the object instance reference storage unit 413 to determine if there are any prospective objects in child cells associated with the cell corresponding to that object configuration template. If the object configuration template inspection unit 407 identifies a reference to a prospective object in a child cell, then the object configuration template inspection unit 407 will have the iterator inspect or retrieve the relevant configuration information from the object configuration template corresponding to that child cell, as discussed in detail above. In this manner, each prospective object can be inspected for matching configuration information, even if the prospective object is connected to other objects in a child cell, a parent cell, or both.

In this manner, the identified object instance storage unit 415 accumulates information referencing objects instances that have been identified as matching specified configuration criteria. Identification information for the identified object instances, such as object instance names, locations, descriptions, corresponding images and the like can be displayed to a user for further examination. For example, some implementations of the invention may display information regarding the identified object instances on an electronic display, such as an electronic monitor or electronic paper. Still other implementations of the invention may alternately or additionally print out information regarding the identified object instances on written medium, such as paper. Still further, some implementations of the invention may save information regarding the identified object instances as electronic data on a computer readable medium.

As described above, various implementations of the invention identify object instances that match specified configuration criteria. To the user, this information is provided as if the hierarchical circuit design data had been searched in a flat manner. As will be appreciated from the foregoing description, however, various embodiments of the invention provide only a virtual flat traversal of hierarchical circuit design data, allowing the actual search to be conducted using the search efficiency inherently provided by a hierarchical organization of the design data.

### CONCLUSION

While the invention has been described with respect to specific examples including presently preferred modes of carrying out the invention, those skilled in the art will appreciate that there are numerous variations and permutations of the above described systems and techniques that fall within the spirit and scope of the invention as set forth in the appended claims. For example, while specific terminology has been employed above to refer to electronic design automation processes, it should be appreciated that various examples of the invention may be implemented using any desired combination of electronic design automation processes.

What is claimed is:

1. A method of identifying objects in a hierarchical circuit design, comprising:
generating object configuration templates for a hierarchical circuit design, each object configuration template
corresponding to a hierarchical cell in the hierarchical circuit design and
having configuration information describing relationships for objects associated with the corresponding hierarchical cell, the configuration information including instance specific configuration information for different instances of the corresponding hierarchical cell; and
analyzing the configuration information of an object configuration template to determine if an instance of an object associated with the corresponding hierarchical cell matches defined configuration criteria.

2. The method recited in claim 1, further comprising displaying the identified object instances.

3. The method recited in claim 2, further comprising displaying the identified object instances by displaying identification information for the object instances on a display monitor.

4. The method recited in claim 2, further comprising displaying the identified object instances by printing identification information for the object instances onto a written medium.

5. The method recited in claim 1, wherein the objects are circuit devices.

6. The method recited in claim 1, wherein the hierarchical circuit design is a hierarchically organized netlist.

7. The method recited in claim 1, wherein the objects are of a single object type.

8. The method recited in claim 7, wherein the objects are of multiple object types.
